(19) United States
(12) Patent Application Publication
(10) Pub. No.: US 2002/0120614 A1
(43) Pub. Date: Aug. 29, 2002

(54) System and method for automated exchange of information with educational institutions

(76) Inventor: Michael P. Kelly, Lake Worth, FL (US)

Correspondence Address: PENNIE AND EDMONDS, 1155 AVENUE OF THE AMERICAS, NEW YORK, NY, 100362711

(21) Appl. No.: 09/793,854

(22) Filed: Feb. 26, 2001

(51) Int. Cl. G06F 7/00

(52) U.S. Cl. 707/3

(57) ABSTRACT

A system and method for verifying educational claims is disclosed. In one embodiment of the invention, a method includes electronically receiving a request from a user for official student information maintained by one or more educational institutions, and automatically and immediately querying current records from the one or more educational institutions to locate the official student information, compiling a report associated with the official student information requested, and transmitting the report to the user. The method wherein the request includes the educational claims, and the compiling of the report includes a comparison of the educational claims with the official student information.

The invention relates to a system and method for verifying educational claims. More particularly, the invention relates to a system and method for verifying educational claims by obtaining relevant information from educational institutions.

### BACKGROUND OF THE INVENTION

Systems and methods for verifying educational claims exist in the art. These systems and methods are often employed to ensure that the educational background and accomplishments claimed by job applicants are accurate before hiring decisions are made. These systems and methods are also employed to confirm enrollment in educational institutions, such as where enrollment in certain institutions influences or determines eligibility to receive credit from a financial institution, a lease from a landlord, or coverage from an insurance company.

In order to request an official confirmation of the applicant's educational claims, traditional systems and methods required eligible requesters to contact the educational institutions, such as high schools, trade schools, colleges or universities, or the records offices of the school systems to which the institutions belonged, that an applicant claimed to attend or to have attended and possibly received educational credit or degrees. These official records were compared with the claims of the applicant to verify the accuracy of the claims. The requester had to convey its request for educational verification by phone, letter, fax or e-mail to the office of the records office, registrar or enrollment service.

Although business needs for this information sometimes extended to foreign countries, different times zones, weekends, evenings and holidays, the request could only be processed during the hours that the records office, registrar or enrollment service office was open. Thus, a request that was submitted by e-mail on Saturday afternoon was unlikely to be processed until Monday morning at the earliest, and then only if an employee of the educational institution was available and had reviewed the request. Additional delays would result where the records office, registrar or enrollment service office was closed due to certain events, such as class registration, graduation, summer recess, or holidays. Additionally, if a requestor wished to verify an applicant's educational claims that spanned multiple educational institutions, the requester would have to contact each of the multiple educational institutions separately.

Because of the deficiencies of the traditional systems, new systems and methods have been created to facilitate the verification process. Some of these systems and methods automate part of this verification process on a school-by-school basis. Thus, such systems and methods handle some of the verification needs of the requesters, and more efficiently do so by automating part of the process traditionally handled by the educational institution employee.

In certain systems, a copy of the updated, official student information is periodically forwarded by the educational institution and loaded onto the systems' central computers, and can be automatically and immediately accessed by requestors seeking verification. Because such systems operate automatically once the student records are updated, the educational claims of an applicant can be verified by a requester at any time, regardless of whether the educational institution's office that holds the official student information is open for business at the time the request is made. In such systems, however, the information is only as current as of the time of the last update, and thus will not represent more recent changes or additions to the information. Updates require manual intervention and thus are not fully automated. Additionally, the operation of such systems inherently risks violation of the Family Educational Rights and Privacy Act (FERPA), a federal law governing the use of educational information. This law allows a student to immediately forbid, or block, an educational institution from providing access to the information by third parties. But where a system periodically downloads the information, the system will not be able to detect whether a student has blocked access to his or her information since the last update of the student's information. Thus, operation of these systems may violate FERPA in cases where a student has his or her records blocked between the time that a system updated his or her information from an educational institution and the time that a requester verified the student's educational claims through use of the system. Also, since educational records require a unique identifier for each person, such as a social security number, many current and former students may be averse to one or more additional copies of their student information residing on computers other than the computer system of the educational institution they attend or attended.

Therefore, there is a need in the art for a system and method that overcomes the drawbacks of systems and methods existing in the art.

There is also a need in the art for a system and method that can automatically and immediately verify educational claims against up-to-the-minute official student information from educational institutions, and can do so regardless of whether the educational institution's records office that maintains the records is currently open for business.

There is also a need for a system that can verify educational claims in compliance with the opt-out rights under FERPA of the person or persons whose information is requested, and that can preserve and protect the person's or persons' privacy rights.

There is also a need for a system that is an outside entity, independent of the one or more educational institutions, such that a requestor will not have to contact each educational institution for which verification is sought.

### SUMMARY OF THE INVENTION

In one embodiment of the invention, a method for an entity independent of an educational institution to verify educational claims includes electronically receiving a request from a user for official student information maintained by one or more educational institutions, and automatically and immediately processing the request by electronically: querying current records from the one or more educational institutions to locate the official student information, compiling a report associated with the official student information requested, and transmitting the report to the user.

The official student information obtained from the one or more educational institutions may remain owned and controlled by the one or more educational institutions. Advantageously, the official student information may be accessed only in read-only format. The official student information may include directory information. This directory information may be defined by each of the one or more educational institutions.

The querying of current records from the one or more educational institutions may include connecting directly with the computerized systems of the one or more educational institutions.

The automatic returning of a report associated with the official student information requested may be contingent upon the absence of the exercise of opt-out rights under FERPA by the person or persons whose information is requested.

The request from the user may include authorization by the person or persons for whom the official student information is sought to allow access to the person's or persons' official student information. An agreement may have been made that all requests for student information will have been authorized.

The method of the present invention may also include communicating the request from the user to the educational institution for manual processing where the request cannot be processed electronically.

The method of the present invention may also include employing security mechanisms to protect its communications.

The request from the user may include the educational claims, and the compiling of the report may include a comparison of the educational claims with the official student information. The comparison may exclude acceptable variances and thereby isolate material misstatements of fact contained in the educational claims. The comparison may include a presentation of the educational claims and the official student information in alignment such that differences in the educational claims and the official student information may be viewed.

In another embodiment of the present invention, a system for an entity independent of an educational institution to verify educational claims includes a computer program embodied in a computer-readable medium and configured to electronically receive a request from a user for official student information maintained by one or more educational institutions, and automatically and immediately process the request by electronically: querying current records from the one or more educational institutions to locate the official student information, compiling a report associated with the official student information requested, and transmitting the report to the user.

The official student information obtained from the one or more educational institutions may remain owned and controlled by the one or more educational institutions. Advantageously, the official student information may be accessed only in read-only format. This official student information may include directory information. The directory information may be defined by each of the one or more educational institutions.

The query of current records from the one or more educational institutions may include direct connection with the computerized systems of the one or more educational institutions.

The automatic return of a report associated with the official student information requested may be contingent upon the absence of the exercise of opt-out rights under FERPA by the person or persons whose information is requested.

The request from the user may include authorization by the person or persons for whom the official student information is sought to allow access to the person's or persons' official student information. An agreement may have been made that all requests for student information will have been authorized.

The computer program embodied in a computer-readable medium may be further configured to communicate the request from the user to the educational institution for manual processing where the request cannot be processed electronically.

The computer program embodied in a computer-readable medium may be further configured to employ security mechanisms to protect its communications.

The request from the user in the system may include the educational claims, and the compiling of the report may include a comparison of the educational claims with the official student information. The comparison may exclude acceptable variances and thereby isolate material misstatements of fact contained in the educational claims. The comparison may include a presentation of the educational claims and the official student information in alignment such that differences in the educational claims and the official student information may be viewed.

The system may be configured as a hub-and-spoke system.

### BRIEF DESCRIPTION OF THE DRAWINGS

The detailed description will be better understood in conjunction with the accompanying drawings, in which like reference characters represent like elements, as follows:

FIG. 1 is a diagram of an improved system for verifying educational claims; and

FIG. 2 is a more detailed diagram of the portion of the system of FIG. 1 that obtains the official student information.

### DETAILED DESCRIPTION OF THE PREFERRED EMBODIMENT

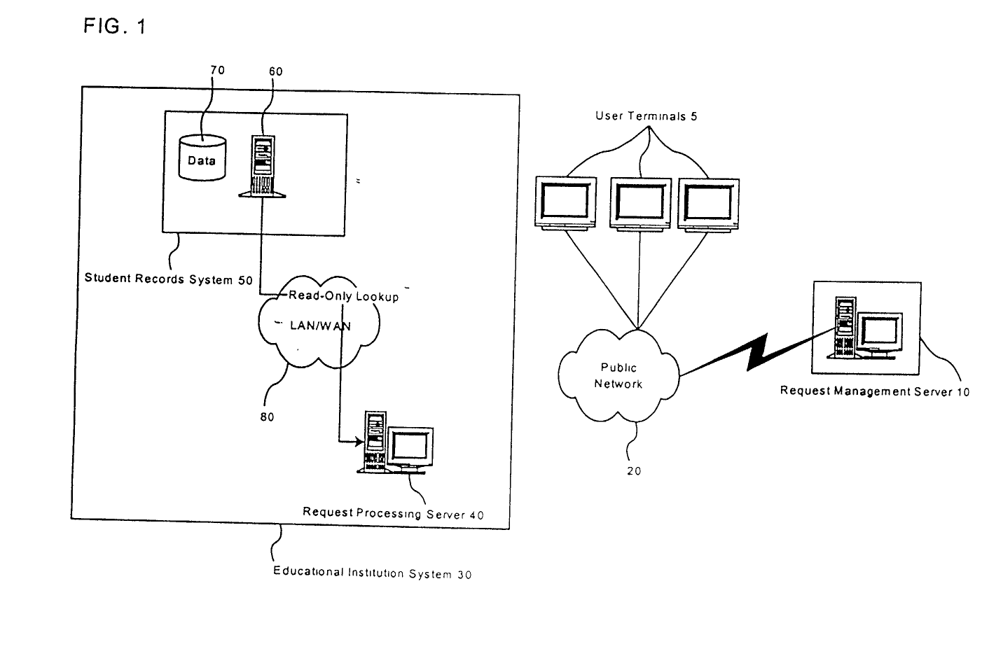

FIG. 1 is a diagram of one embodiment of a system for automatically and immediately verifying educational claims in accordance with the present invention. Educational claims may include enrollment, degree, transcript, and other information associated with a student or former student's experience regarding an educational institution or institutions. The educational institutions may be, for example, high schools, trade schools, colleges, universities, or the records offices of the school systems to which any of these institutions belong. In this system, users, which may be employers or other entities or persons desiring official student information regarding particular applicants or other persons (hereinafter “applicants”), employ user terminals 5 to access the system. User terminals 5 may be conventional computerized devices having the ability to connect to other computerized devices or servers through public networks, such as the Internet.

User terminals 5 connect to request management server 10 through public network 20, to transmit requests for official student information from and maintained by an educational institution. The information transmitted in the request by the user includes information sufficient to identify the applicants and the educational institution that should be queried. For example, the information transmitted may include the name of the educational institution in which enrollment and/or attainment are claimed social security numbers or student identification of the applicants, as well as at least one date of record (such as enrollment date or graduation date). The official student information is information associated with a particular applicant's experience with an educational institution. This information preferably includes directory information, which may include the applicant's name, the educational institution he or she attended, dates of enrollment, dates of graduation, and/or course of study and degree, if any. An educational institution may extend the definition of “directory information” to include grade-point average (GPA), athletic accomplishments, offices held, and/or other criteria associated with the applicant's educational experience. Preferably, the request transmitted by the user will be authorized by the person or persons for whom official student information is being requested. In this case, operation of the system and method of the present invention may require agreement or contract with participating educational institutions that all requests for student information will have been authorized. The users of user terminals 5 may communicate with request management server 10 via conventional communications software that can receive and process the information provided by the request.

Request management server 10 then communicates with educational institution system 30 to electronically request official student information maintained by a particular educational institution. For example, request management server 10 may interact with educational institution system 30 via an object-access protocol software, such as Microsoft's Simple Object Access Protocol (SOAP) to allow remote configuration, management, and updates of the system and method of the present invention. The communication between request management server 10 and educational institution system 30 includes transmitting the identification of an applicant for which a user, through user terminal 5, requested official student information. Educational institution system 30 preferably comprises a request processing server 40 that communicates with student records system 50, which generally includes processor 60 and storage device 70, to search for and obtain the requested official student information. In one embodiment, educational institution system 30 comprises a request processing server 40 that communicates with student records system 50 through network 80, a wide-area network (WAN) or local-area network (LAN). Advantageously, request processing server 40 is located in proximity to the educational institution, as defined above, for convenient connection and communication between request processing server 40 and student records system 50. The request processing server 40 accesses current records in read-only format. Access to “current” records means real-time access to the most up-to-date student records maintained by the educational institution. Read-only access ensures that no alteration of official student records as maintained by student records system 50 is possible by communicating with student records system 50 through request processing server 40.

After the request for official student information has been communicated by request management server 10 to educational institution system 30, educational institution system 30 queries current student records that are electronically stored by the educational institution to locate the official student information. This process of querying the current records may be completed by conventional software that is able to search for specific information stored in a conventional computerized system.

Once the official student information has been located by educational institution system 30, educational institution system 30 processes the information, and transmits the information to request management server 10. Request management server 10 may then compile reports associated with the official student information requested. The reports preferably include the directory information.

The reports may now be automatically transmitted to the requesting users such that the report is accessible by the users. For example, each requesting user may now access, through public network 20, a report of the user's requested official student information maintained by request management server 10. Alternatively or in addition, the reports may be transmitted through public network 20 to the user terminals 5 or to a server or network accessible via user terminals 5. By obtaining the official student information directly from the educational institution, the system and method of the present invention advantageously does not create a database of official records separate from those maintained by the educational institution. Thus, only one database of records, which is official and up-to-date, remains in existence.

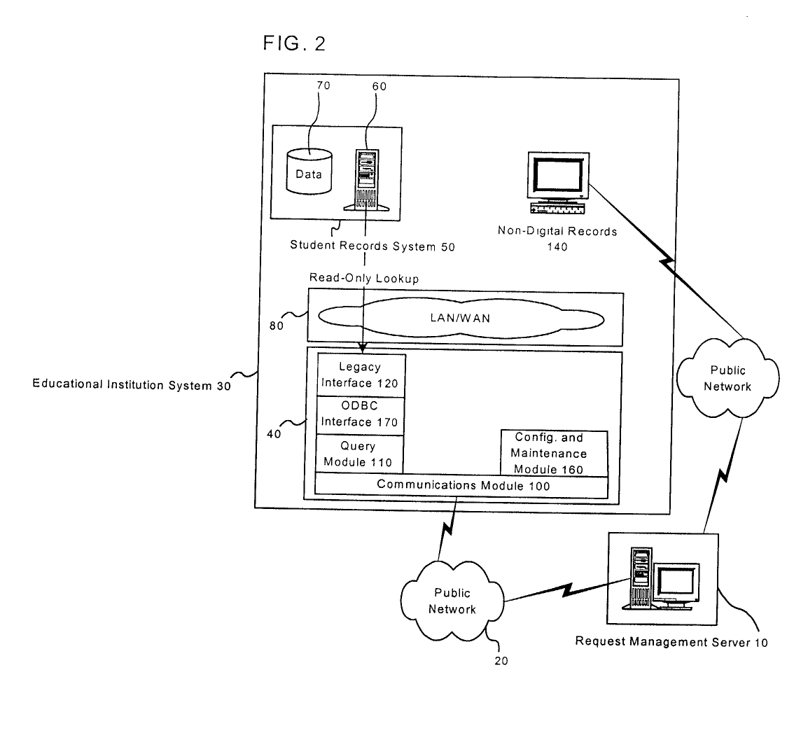

Preferably, in the embodiment involving request processing server 40, request processing server 40 is configured as shown in FIG. 2. Thus, the requests transmitted by request management server 10 may be received by communications module 100 of request processing server 40 of educational institution system 30. Communications module 100 formats the information transmitted by the request, in a form that can be used to search, or query, student records system 50 for the desired student information. The formatted request may then be employed by query module 110 to search for the pertinent official student information. Preferably, query module 110 communicates with student records system 50 through ODBC (Open Database Connectivity) Interface 170, a module that may use conventional computerized system means to manage the connection between request processing server 40 and student records system 50. For systems that are not configured for ODBC communication, legacy interface 120 may publish a view based on a query executed against a known database server that is not ODBC-compliant. Once the pertinent official student information is located, the information is transmitted from student records system 50 to query module 110, where it is transmitted back to communications module 100 and processed and compiled as a report for transmission back to request management server 10 for viewing or downloading by the user operating user terminal 5. In one embodiment, extensible mark-up language (XML) may be employed during the processing of the data into a desired format for transmission to request management server 10 or to user terminal 5.

In one embodiment of the present invention, where a request cannot be satisfied electronically by the processes described above, such as where the user seeks verification of official student information of an alumnus of the educational institution who graduated prior to the availability of digital records, the request returns a negative response from student records system 50 to request management server 10. In this event, request management server 10 automatically prepares and transmits a communication to the employee of the educational institution who is responsible for manual verification. This communication can take the form of an encrypted e-mail or a facsimile. The employee who receives the automated communication manually prepares the verification information by conducting a manual search of student records, such as reviewing paper files or micro fiche records that contain the official student information, and communicates the information to request management server 10. The communication to request management server 10 may take the form of an entry on non-digital records system 140, which is a secure web site preferably operating on a LAN/WAN, or another conventional system, which communicates with request management server 10 over public network 20. Alternatively, the educational institution's employee may manually transcribe the educational information on a hard copy printout of the facsimile or e-mail and transmit it to the staff or organization that is operating request management server 10, who then enters the official student information onto request management server 10.

Preferably, the embodiment that includes request processing server 40 also includes configuration and maintenance module 160. This module facilitates the configuration of the other modules (i.e. communications module 100, query module 110, ODBC interface 170 and legacy interface 120). This configuration can include parameters such as IP address, user access accounts and rights, student records database layout, etc. Preferably, the educational institution from which the official student information is being obtained will maintain complete control of this information through control of configuration and maintenance module 160. For example, the educational institution may determine eligibility for accessing the student records by requiring users of the system or method to obtain and maintain access accounts.

Preferably, the systems and methods of the present invention described above will employ security mechanisms to ensure that the student records and/or educational claims are not easily accessed by unauthorized users. For example, the system and method may use a combination of SSL (“Secure Sockets Layer”) technology, encryption, or other security techniques employed when private data is to be transmitted over public networks such as the Internet, password restricted access (on both the web site and database), and read-only access to the school database. If required, any firewall and/or proxy services employed by the educational institution may have to be configured to allow access to the system and method through the public network by request management server 10. The above security mechanisms may apply to any or all transmissions of official student information and educational claims or reports associated therewith over public networks or carriers, or otherwise where there might be a risk of interception of the communications of the systems and methods.

One implementation of the systems and methods above may include a feature that automatically or semi-automatically performs a comparison of the applicants' educational claims versus the applicants' official student records, discerns which variations are significant, and prepares an associated report. In this implementation, the user transmits the educational claims of an applicant as part of the information submitted in the request for verification of the educational claims transmitted from user terminal 5 to request management server 10. After the systems and methods above have processed the request and transmitted the official student information to request management server 10, request management server 10 compares it to the educational claims contained in the request for verification to determine if the official student information and educational claims match. Request management server 10 then may prepare a report that aligns, for easy visual comparison by the user, the applicant's educational claims and the official student information so that differences in the educational claims and the official student information may be determined. This report may then be transmitted over public network 20 for viewing or downloading by the user.

In another implementation, request management server 10 is equipped with a module that enables it to compare the educational claims with the official student records to exclude acceptable variances and thereby isolate material misstatements of fact contained in the educational claims submitted by the user. An acceptable variance may be, for example, a claim that an applicant graduated on mar. 10, 1990 where the official student records state that the applicant graduated on Mar. 3, 1990. A material misstatement of fact may be, for example, a claim that an applicant obtained a bachelor of science degree where the official student records state that the applicant actually obtained a bachelor of arts degree. But acceptable variances and material misstatements of fact may be defined as desired. This module then prepares a report for the user that groups together all applicants whose claims are accurate within predetermined tolerances, and an additional grouping that identifies applicants who materially misstated their educational claims. The report may detail specific material misstatements by the latter. This report may then be transmitted over public network 20 for viewing or downloading by the user operating user terminal 5.

Preferably, the systems and methods in accordance with the present invention employ multiple educational institution systems 30 such that request management server 10 may access the particular educational institution systems 30 for which official student information is sought. Thus, each educational institution system 30 will be in communication with a different educational institution, and a request for official student information of a person who attended more than one educational institution may require the system and method of the present invention to employ more than one educational institution system 30 to process the request. Similarly, the system and method of the present invention can process a request for official student information of multiple students that have official student information maintained by multiple educational institutions. Here, the request from the user preferably includes identification of the specific educational institutions to which an applicant or applicants have made educational claims. Request management server 10 processes the request to identify which educational institution or institutions to query. Thus, for one applicant, the request includes information sufficient to identify the applicant, such as a social security number or a school identifier, plus one or more inquiries regarding the applicant's educational claims. Each inquiry may correspond to a different educational institution or a different request within the same educational institution for which verification of the applicant's educational claims is sought. The system in this embodiment may be configured as a hub-and-spoke system, which is a specific network arrangement employing multiple nodes. The “hub” is request management server 10, and each “spoke” is a separate system, such as described in the embodiments above, for communicating and processing information between request management server 10 and a specific educational institution. Advantageously, each spoke is configured such that a processing server 40 is located in proximity to an educational institution, as defined above, for convenient connection and communication between request processing server 40 and student records system 50. The system may also include additional hubs configured with the spokes, as desired.

While the foregoing description and drawings represent the preferred embodiments of the present invention, it will be understood that various additions, modifications, and substitutions may be made without departing from the spirit and scope of the present invention as defined in the accompanying claims. In particular, it will be clear to those skilled in the art that the present invention may be embodied in other specific methods, forms, structures, arrangements, proportions, and with other elements, materials, and components, without departing from the spirit or essential characteristics of the invention. It will be appreciated that features described with respect to one embodiment typically may be applied to another embodiment, whether or not explicitly indicated. The various features described may be used singly or in any combination. The presently disclosed embodiments are therefore to be considered in all respects as illustrative and not restrictive, the scope of the invention being indicated by the appended claims, and not limited to the foregoing description.

1. A method for an entity independent of an educational institution to verify educational claims, comprising:
electronically receiving a request from a user for official student information maintained by one or more educational institutions; and
automatically and immediately processing the request by electronically:
querying current records from the one or more educational institutions to locate the official student information;
compiling a report associated with the official student information requested; and
transmitting the report to the user.

2. The method of claim 1, wherein the official student information obtained from the one or more educational institutions remains owned and controlled by the one or more educational institutions.

3. The method of claim 2, wherein the official student infonnation may be accessed only in read-only format.

4. The method of claim 1, wherein the official student information comprises directory information.

5. The method of claim 4, wherein the directory information is defined by each of the one or more educational institutions.

6. The method of claim 1, wherein the querying of current records from the one or more educational institutions comprises connecting directly with the computerized systems of the one or more educational institutions.

7. The method of claim 1, wherein the automatic returning of a report associated with the official student information requested is contingent upon the absence of the exercise of opt-out rights under FERPA by the person or persons whose information is requested.

8. The method of claim 1, wherein the request from the user comprises authorization by the person or persons for whom the official student information is sought to access the person's or persons' official student information.

9. The method of claim 8, wherein an agreement is made that all requests for student information will have been authorized.

10. The method of claim 1, further comprising communicating the request from the user to the educational institution for manual processing where the request cannot be processed electronically.

11. The method of claim 1, further comprising employing security mechanisms to protect the communications of the method.

12. The method of claim 1, wherein the request comprises the educational claims, and the compiling of the report comprises a comparison of the educational claims with the official student information.

13. The method of claim 12, wherein the comparison comprises excluding acceptable variances and thereby isolating material misstatements of fact contained in the educational claims.

14. The method of claim 12, wherein the comparison comprises a presentation of the educational claims and the official student information in alignment such that differences between the educational claims the official student information may be viewed.

15. A system for an entity independent of an educational institution to verify educational claims, comprising a computer program embodied in a computer-readable medium and configured to:
electronically receive a request from a user for official student information maintained by one or more educational institutions; and
automatically and immediately process the request by:
querying current records from the one or more educational institutions to locate the official student information;
compiling a report associated with the official student information requested; and
transmitting the report to the user.

16. The system of claim 15, wherein the official student information obtained from the one or more educational institutions remains owned and controlled by the one or more educational institutions.

17. The system of claim 16, wherein the official student information may be accessed only in read-only format.

18. The system of claim 15, wherein the official student information comprises directory information.

19. The system of claim 18, wherein the directory information is defined by each of the one or more educational institutions.

20. The system of claim 15, wherein the query of current records from the one or more educational institutions comprises direct connection with the computerized systems of the one or more educational institutions.

21. The system of claim 15, wherein the automatic return of a report associated with the official student information requested is contingent upon the absence of the exercise of opt-out rights under FERPA by the person or persons whose information is requested.

22. The system of claim 15, wherein the request from the user comprises authorization by the person or persons for whom the official student information is sought to allow access to the person's or persons' official student information.

23. The system of claim 22, wherein all requests for student information will have been authorized by an agreement.

24. The system of claim 15, wherein the computer program embodied in a computer-readable medium is further configured to communicate the request from the user to the educational institution for manual processing where the request cannot be processed electronically.

25. The system of claim 15, wherein the computer program embodied in a computer-readable medium is further configured to employ security mechanisms to protect the communications of the system.

26. The system of claim 15, wherein the request from the user comprises the educational claims, and the compiling of the report comprises a comparison of the educational claims with the official student information.

27. The system of claim 26, wherein the comparison comprises excluding acceptable variances and thereby isolating material misstatements of fact contained in the educational claims.

28. The system of claim 26, wherein the comparison comprises a presentation of the educational claims and the official student information in alignment such that differences in the educational claims and the official student information may be viewed.

29. The system of claim 15, wherein the system is configured as a hub-and-spoke system.

30. A system for an entity independent of an educational institution to verify educational claims, comprising:
means for electronically receiving a request from a user for official student information maintained by one or more educational institutions;
means for automatically and immediately:
querying current records from the one or more educational institutions to locate the official student information;
compiling a report associated with the official student information requested; and
transmitting the report to the user.
